(19) United States
(12) Patent Application Publication
(10) Pub. No.: US 2011/0121929 A1
(43) Pub. Date: May 26, 2011

(54) Inductor Structure

(76) Inventor: Jen-Chien Lo, Xizhi City (TW)

(21) Appl. No.: 12/893,019

(22) Filed: Sep. 29, 2010

(30) Foreign Application Priority Data
Nov. 20, 2009 (TW) 098221856

(51) Int. Cl. H01F 27/04

(52) U.S. Cl. 336/90

(57) ABSTRACT

An inductor structure includes a hollow outer housing, an inner magnetic core, and a coil wound around the inner magnetic core. The outer housing includes two spaced sidewalls. The inner magnetic core and the coil are received in the outer housing, and a gap is defined between each of two ends of the inner magnetic core and one of the sidewalls of the outer housing in a length direction. The inner magnetic core is provided with opposite first and second recessed portions respectively defined in two sides of the inner magnetic core and extending in a vertical direction perpendicular to the length direction, so that the inductor structure can be conveniently adjusted to the desired saturation characteristic.

### BACKGROUND OF THE INVENTION

1. Field of the Invention

The present invention relates to an inductor structure and, more particularly, to a choke coil adapted to filter wave, to reject noise, and/or to resist electromagnetic interference.

2. Description of the Related Art

An inductor is widely used in networks, telecommunication, computers, AC power supplies and peripheral equipment to filter wave, to reject noise and/or to resist electromagnetic interference (EMI). Conventional inductors generally include a metallic coil that is wound into a helix shape, and an outer surface of the coil is coated with insulation film to form an insulated wire such as an enameled wire. An inner magnetic core formed by iron powder or ferrite material is received in the coil. The coil and the inner magnetic core are received within an outer housing that is used as a shielding case and generally made up of ferrite material. There is usually an air gap between the outer housing and the inner magnetic core to prevent the core from saturating. However, higher inductance value may not be provided to generate larger ripple rejection capability when the power supply circuit provides a small current, resulting in high loss of the power module and low working efficiency. On the other hand, saturation as well as overheating could usually happen in the ferrite core with an air gap when the power supply circuit provides a high current.

### BRIEF SUMMARY OF THE INVENTION

Therefore, it is an objective of the present invention to overcome the aforementioned shortcoming and deficiency of the prior art by providing an inductor structure that facilitates the control of the shape of current saturation curve and has a high mass production yield rate. In addition, at lower loading or small current, the inductor can have a higher inductance value so as to generate larger ripple rejection capability. Thus, the loss of a power module is greatly reduced and the working efficiency is enhanced.

To achieve the foregoing objective, an inductor structure of the present invention includes an outer housing, an inner magnetic core, and a coil. The outer housing includes a compartment defined therein and two sidewalls spaced in a length direction. The inner magnetic core is received in the compartment of the outer housing and includes first and second ends spaced in the length direction and respectively facing the sidewalls of the outer housing. A gap is defined between each of the first and second ends of the inner magnetic core and one of the sidewalls of the outer housing in the length direction. The inner magnetic core further includes two sides spaced in a width direction perpendicular to the length direction. The inner magnetic core further includes a first recessed portion defined in one of the two sides of the inner magnetic core and extending in a vertical direction perpendicular to the length and width directions. The coil is wound around the inner magnetic core and received in the compartment of the outer housing. The coil includes first and second wire ends extending out of the outer housing.

In a preferred form, the inner magnetic core further includes a second recessed portion defined in the other of the two sides of the inner magnetic core and opposite to the first recessed portion. The inner magnetic core further includes upper and lower portions spaced in the vertical direction. Each of the first and second recessed portions is located in a central portion between the first and second ends of the inner magnetic core in the length direction and spaced from the upper and lower portions of the inner magnetic core.

In another preferred form, each of the first and second recessed portions is located in a central portion between the first and second ends of the inner magnetic core in the length direction and extends from the upper portion of the inner magnetic core to the lower portion of the inner magnetic core. The inner magnetic core is a square column made of ferrite magnetic material, and the outer housing is a hollow cube made of ferrite magnetic material. The inner magnetic core further includes opposite third and fourth recessed portions respectively defined in the upper and lower portions of the inner magnetic core and extending in the width direction. The third and fourth recessed portions are located in the central portion between the first and second ends of the inner magnetic core in the length direction and interconnected with the first and second recessed portions.

In a further preferred form, the inner magnetic core is a round column made of ferrite magnetic material. The first and second recessed portions define an annular recessed portion extending around the inner magnetic core and located in a central portion between the first and second ends of the inner magnetic core in the length direction.

The present invention will become clearer in light of the following detailed description of illustrative embodiments of this invention described in connection with the drawings.

### DESCRIPTION OF THE DRAWINGS

The illustrative embodiments may best be described by reference to the accompanying drawings where:

FIG. 1 shows a perspective view of an inductor according to a first embodiment of the present invention;

FIG. 2 shows an exploded, perspective view of the inductor of FIG. 1;

FIG. 3 is a cross sectional view taken along plane 3-3 in FIG. 2;

FIG. 4 is a cross sectional view taken along plane 4-4 in FIG. 1;

FIG. 5 shows an exploded, perspective view of an inductor according to a second embodiment of the present invention;

FIG. 6 shows an exploded, perspective view of an inductor according to a third embodiment of the present invention;

FIG. 7 shows an exploded, perspective view of an inductor according to a fourth embodiment of the present invention; and

FIG. 8 shows an exploded, perspective view of an inductor according to a fifth embodiment of the present invention.

### DETAILED DESCRIPTION OF THE INVENTION

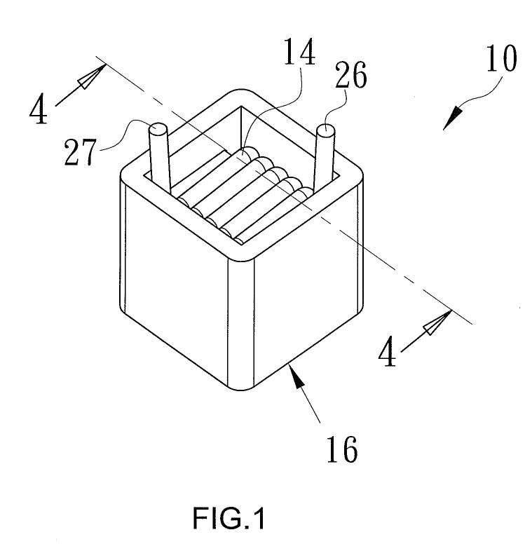

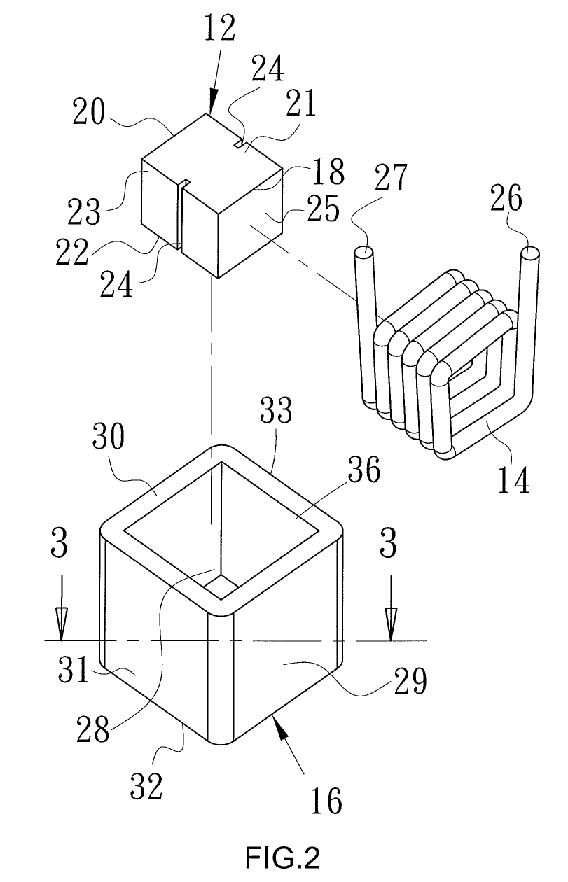

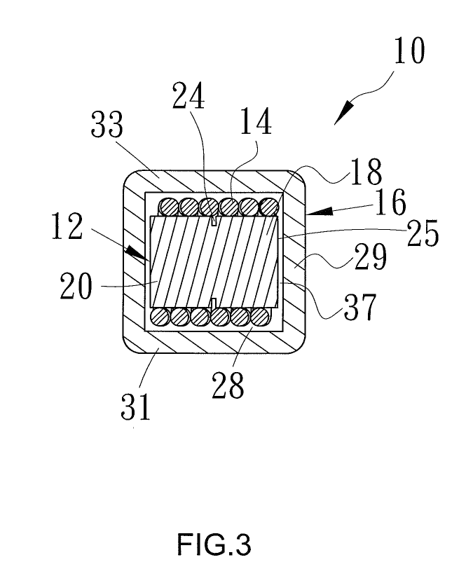

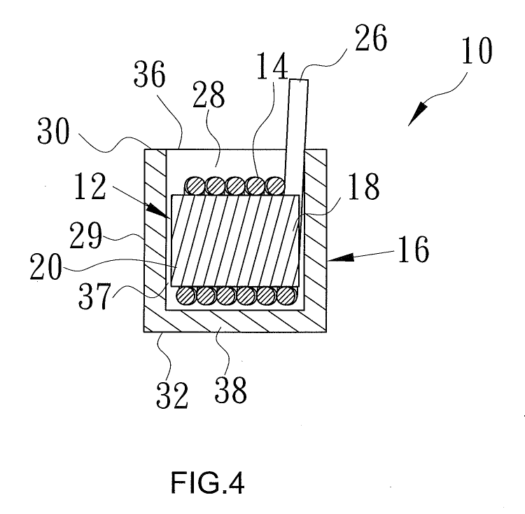

An inductor of a first embodiment of the present invention is shown in FIGS. 1 through 4 of the drawings and generally designated 10. Inductor 10 is adapted for use in, for example, networks, telecommunication, computers, or AC power supplies to filter wave, to reject noise, and/or resist electromagnetic interference. Inductor 10 includes an inner magnetic core 12, a coil 14, and a hollow outer housing 16.

In this embodiment, inner magnetic core 12 is a square column made of ferrite magnetic material and includes first and second ends 18 and 20 spaced in a length direction. Inner magnetic core 12 further includes upper and lower portions 21 and 22 spaced in a vertical direction perpendicular to the length direction. Inner magnetic core 12 further includes two sides 23 spaced in a width direction perpendicular to the length and vertical directions. Inner magnetic core 12 further includes opposite first and second recessed portions 24 respectively defined in sides 23 of inner magnetic core 12 and extending in the vertical direction. In this embodiment, each of the first and second recessed portions 24 extends from the upper portion 21 to the lower portion 22 and is located in a central portion between first and second ends 18 and 20 of inner magnetic core 12 in the length direction. Further, each of the first and second ends 18 and 20 includes an end face 25.

In this embodiment, coil 14 is a helix shape wire covered with an insulation film and includes first and second wire ends 26 and 27. Coil 14 is wound around an outer periphery of inner magnetic core 12 along the length direction. In this embodiment, coil 14 is wound around the outer periphery of inner magnetic core 12 for only one layer. Alternatively, coil 14 may be wound around inner magnetic core 12 for more than one layer.

Outer housing 16 is a shielding case made of ferrite magnetic material and includes a compartment 28 defined therein. In this embodiment, outer housing 16 is a hollow cube and includes two sidewalls 29 spaced in the length direction. Outer housing 16 further includes upper and lower ends 30 and 32 spaced in the vertical direction and front and rear walls 31 and 33 spaced in the width direction. In this embodiment, an opening 36 is formed in upper end 30 of outer housing 16, and a bottom wall 38 is formed on lower end 32 of outer housing 16. Inner magnetic core 12 and coil 14 are received in compartment 28 of outer housing 16 through opening 36 such that first and second ends 18 and 20 of inner magnetic core 12 respectively face sidewalls 29 of outer housing 16. Wire ends 26 and 27 of coil 14 extend out of outer housing 16 through opening 36 so as to be connected to a power circuit (not shown). Coil 14 can be, through adhesive, engaged with front and rear walls 31 and 33 of outer housing 16 to maintain the stability of inductance. After inner magnetic core 12 and coil 14 are placed in outer housing 16, dielectric packaging material (for example, epoxy resin) can be injected into compartment 28 to position inner magnetic core 12 and coil 14 in place.

In accordance with the present invention, a gap 37 is defined between each of first and second ends 18 and 20 of inner magnetic core 12 and one of the sidewalls 29 of outer housing 16 in the length direction when inner magnetic core 12 and coil 14 are placed into compartment 28 of outer housing 16. In this embodiment, each gap 37 is about 0.05-0.15 mm so that respective air gaps are formed between end faces 25 of first and second ends 18 and 20 of inner magnetic core 12 and sidewalls 29 of outer housing 16 to prevent inner magnetic core 12 from saturating. Further, with the first and second recessed portions 24 of inner magnetic core 12, the shape of the saturation curve of inductor 10 can be controlled and adjusted. Specifically, without the first and second recessed portions 24 provided in inner magnetic core 12, inductance characteristic will get to fast transition and drop when the inner magnetic core 12 of inductor 10 gets close to saturation; but with the first and second recessed portions 24 provided in inner magnetic core 12, inductance characteristic can be buffered when inner magnetic core 12 gets close to saturation. Furthermore, through the adjustment of shape and location of the first and second recessed portions 24, the shape of the current saturation curve can be controlled easily. Further, inductor 10 can have a higher inductance value at smaller current to generate larger ripple rejection capability, thereby reducing the loss of the power module and enhancing the working efficiency.

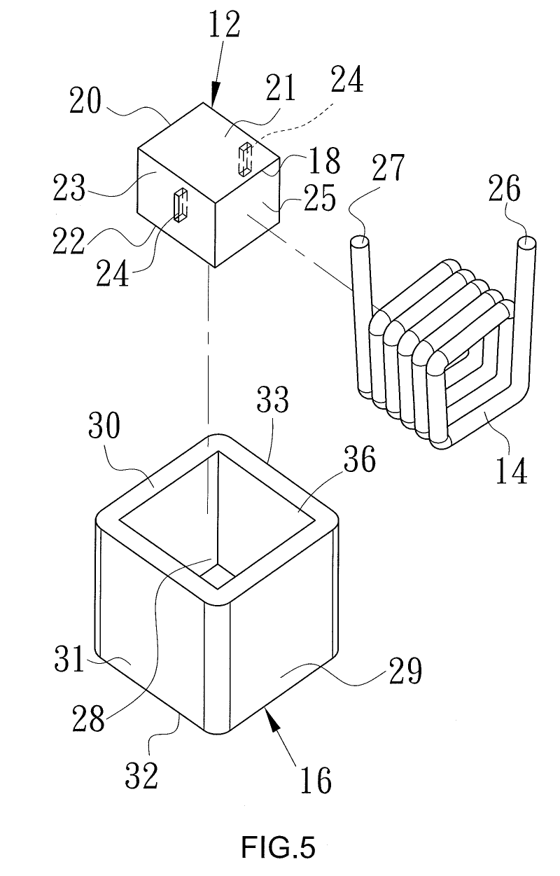

Now that the basic teachings of the present invention have been explained, many extensions and variations will be obvious to one having ordinary skill in the art. FIG. 5 shows inductor 10 of a second preferred embodiment of the present invention modified from the first embodiment. Description of the parts of inductor 10 shown in FIG. 5 identical to those shown in FIGS. 1 through 4 is omitted. In particular, each of the first and second recessed portions 24 in sides 23 of inner magnetic core 12 extends in the vertical direction and is spaced from upper and lower portions 21 and 22 of inner magnetic core 12.

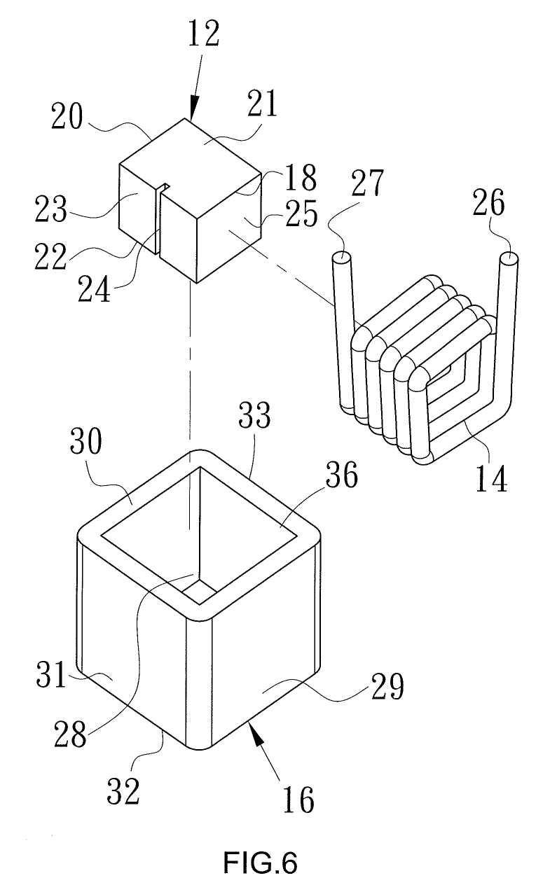

FIG. 6 shows inductor 10 of a third preferred embodiment of the present invention modified from the first embodiment. In this embodiment, inner magnetic core 12 is provided with only one recessed portion (first recessed portion) 24 defined in one of sides 23 of inner magnetic core 12 and extending from the upper portion 21 to the lower portion 22 in the vertical direction.

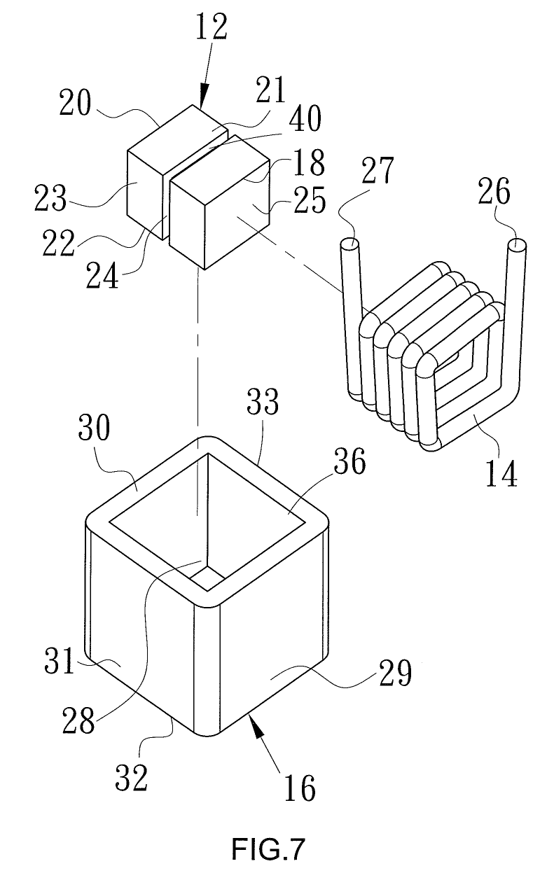

FIG. 7 shows inductor 10 of a fourth preferred embodiment of the present invention modified from the first embodiment. In this embodiment, inner magnetic core 12 further includes opposite third and fourth recessed portions 40 respectively defined in upper and lower portions 21 and 22 of inner magnetic core 12 and extending in the width direction. Further, third and fourth recessed portions 40 are located in the central portion between first and second ends 18 and 20 of inner magnetic core 12 in the length direction and interconnected with first and second recessed portions 24 such that first, second, third, and fourth recessed portions 24 and 40 together define an annular recessed portion extending around the outer periphery of inner magnetic core 12.

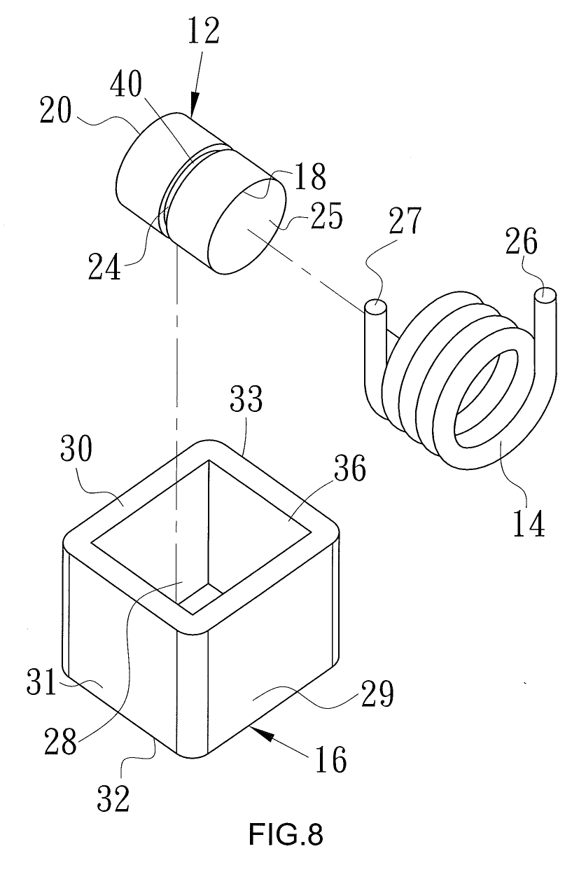

FIG. 8 shows inductor 10 of a fifth preferred embodiment of the present invention modified from the fourth embodiment. In this embodiment, inner magnetic core 12 is a round column made of ferrite magnetic material, and coil 14 is wound around inner magnetic core 12 along the length direction in a cylindrical shape. Recessed portions 24 and 40 define an annular recessed portion extending around the outer periphery of inner magnetic core 12 and located in the central portion between first and second ends 18 and 20 of inner magnetic core 12 in the length direction.

Thus since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims, rather than by the foregoing description, and all changes which come within the meaning and range of equivalency of the claims are intended to be embraced therein.

1. An inductor structure comprising, in combination:
an outer housing including a compartment defined therein, with the outer housing including two sidewalls spaced in a length direction;
an inner magnetic core received in the compartment of the outer housing, with the inner magnetic core including first and second ends spaced in the length direction, with the first and second ends of the inner magnetic core respectively facing the two sidewalls of the outer housing, with a gap defined between each of the first and second ends of the inner magnetic core and one of the sidewalls of the outer housing in the length direction, with the inner magnetic core further including two sides spaced in a width direction perpendicular to the length direction, with the inner magnetic core further including a first recessed portion defined in one of the two sides of the inner magnetic core and extending in a vertical direction perpendicular to the length and width directions; and
a coil wound around the inner magnetic core and received in the compartment of the outer housing, and with the coil including first and second wire ends extending out of the outer housing.

2. The inductor structure according to claim 1, with the inner magnetic core further including upper and lower portions spaced in the vertical direction, and with the first recessed portion located in a central portion between the first and second ends of the inner magnetic core in the length direction and spaced from the upper and lower portions of the inner magnetic core.

3. The inductor structure according to claim 1, with the inner magnetic core further including upper and lower portions spaced in the vertical direction, and with the first recessed portion located in a central portion between the first and second ends of the inner magnetic core in the length direction and extending from the upper portion of the inner magnetic core to the lower portion of the inner magnetic core in the vertical direction.

4. The inductor structure according to claim 1, with the inner magnetic core further including a second recessed portion defined in the other of the two sides of the inner magnetic core and opposite to the first recessed portion.

5. The inductor structure according to claim 4, with the inner magnetic core further including upper and lower portions spaced in the vertical direction, and with each of the first and second recessed portions located in a central portion between the first and second ends of the inner magnetic core in the length direction and spaced from the upper and lower portions of the inner magnetic core.

6. The inductor structure according to claim 4, with the inner magnetic core further including upper and lower portions spaced in the vertical direction, and with each of the first and second recessed portions located in a central portion between the first and second ends of the inner magnetic core in the length direction and extending from the upper portion of the inner magnetic core to the lower portion of the inner magnetic core.

7. The inductor structure according to claim 6, with the inner magnetic core being a square column made of ferrite magnetic material, with the outer housing being a hollow cube made of ferrite magnetic material, with the outer housing further including upper and lower ends spaced in the vertical direction, with the outer housing further including an opening formed in the upper end of the outer housing, and with the first and second wire ends of the coil extend out of the upper end of the outer housing.

8. The inductor structure according to claim 7, with the inner magnetic core further including opposite third and fourth recessed portions respectively defined in the upper and lower portions of the inner magnetic core and extending in the width direction, and with the third and fourth recessed portions located in the central portion between the first and second ends of the inner magnetic core in the length direction and interconnected with the first and second recessed portions.

9. The inductor structure according to claim 4, with the inner magnetic core being a round column made of ferrite magnetic material, with the outer housing being a hollow cube made of ferrite magnetic material, and with the first and second recessed portions defining an annular recessed portion extending around the inner magnetic core and located in a central portion between the first and second ends of the inner magnetic core in the length direction.

10. The inductor structure according to claim 9, with the outer housing further including upper and lower ends spaced in the vertical direction, with the outer housing further including an opening formed in the upper end of the outer housing, and with the first and second wire ends of the coil extend out of the upper end of the outer housing.
